(19) United States
(12) Patent Application Publication
(10) Pub. No.: US 2010/0033494 A1
(43) Pub. Date: Feb. 11, 2010

(54) GAMUT MAPPING

(75) Inventors: Michiel Adriaanszoon Klompenhouwer, Eindhoven (NL); Gerben Johannes Maria Hekstra, Eindhoven (NL); Mathias Hubertus Godefrida Peeters, Eindhoven (NL); Ruben Rajagopalan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/445,472

(22) PCT Filed: Oct. 15, 2007
(86) PCT No.: PCT/IB07/54178

§ 371 Date: Apr. 14, 2009

(30) Foreign Application Priority Data
Oct. 19, 2006 (EP) 06122574.4
May 4, 2007 (EP) 07107499.1

(51) Int. Cl. G09G 5/02; G06K 9/40

(52) U.S. Cl. 345/590; 382/167; 382/261; 382/263; 345/604

(57) ABSTRACT

A color mapping system comprises a detail detector (1) to generate a control signal (CS) which indicates local detail in an input image signal (IS). The system further comprises a color mapper (2) which maps a first image signal (FIS) into a mapped image signal (MIS) under control of the control signal (CS) for locally changing an intensity and/or a saturation of the first image signal (FIS) as a function of the local detail. The first image signal (FIS) is the input image signal (IS) or a low-pass filtered input image signal (LIS).

### FIELD OF THE INVENTION

The invention relates to a color mapping system, a conversion system for converting an M-primary image signal into an N-primary image signal, a display apparatus, a color mapping method, and a computer program product.

### BACKGROUND OF THE INVENTION

Gamut mapping is known from systems which have an input image signal defined in an input gamut which is different than an output gamut of a display device on which the image has to be displayed. For example for an RGBW (Red, Green, Blue, White) display which has pixels each comprising a red, green, blue and white sub-pixel, a gamut mapping maps the standard RGB (Red, Green, Blue) input signal into a mapped image signal which can be displayed on the sub-pixels of the RGBW display. The sub-pixels, emit light with corresponding colors referred to as the display primaries. Usually, this mapping only involves the process of determining how the colors in the input color space defined by the input image signal RGB have to be mapped in the input color space to colors which fit the output gamut defined by the RGBW primaries. A successive multi-primary conversion converts the mapped colors to drive signals for the RGBW sub-pixels. The operation of the prior art gamut mapping and multi-primary conversion will be discussed in more detail with respect to FIGS. 2A to 2C. It is a drawback of the known color mapping or gamut mapping systems that artifacts occur for particular input image structures.

### SUMMARY OF THE INVENTION

It is an object of the invention to improve the picture quality of the color mapped image signal.

A first aspect of the invention provides a color mapping system as claimed in claim 1. A second aspect of the invention provides a conversion system as claimed in claim 13. A third aspect of the invention provides a display apparatus as claimed in claim 15. A fourth aspect of the invention provides a color mapping method as claimed in claim 16.

A fifth aspect of the invention provides a computer program product as claimed in claim 17. Advantageous embodiments are defined in the dependent claims.

A color mapping system in accordance with the first aspect of the invention comprises a detail detector which generates a control signal indicating a local detail in an input image signal. With detail should be understood the local image structure, i.e. not necessarily the presence of a high frequency local pattern, but also the absence of it, i.e. e.g. a uniform region, possibly apart from some noise (in this text we will usually mean with detail small grain or high frequency detail). The term color mapping is used to indicate any mapping of colors of an input image into colors of an output image, independent on whether the input and output gamuts are different or not. Gamut mapping is considered to be a special case wherein the color mapping occurs for different gamuts. Due to the color mapping, at least one color of the input signal is mapped on a different color at the output of the color mapper. With color is meant luminance, saturation, and/or hue.

The input image signal has images composed of pixels. The color and intensity of each one of the pixels is defined by input signal samples which comprise components which directly (RGB) or indirectly (YUV) define the intensity of each one of the primaries used for representing the input image signal. For full color images, at least three differently colored primaries are required. These primaries define the gamut of the input signal. An image may be a photo, a picture of a film, or a computer generated image which may be a composition of text and photo and/or film.

The detail detector checks for each pixel of the input image the detail present in a local area including the pixel. For example, the difference between the sample of a previous pixel and the sample of the present pixel which has to be color mapped is determined. The higher this difference is the more high frequent detail is present. This difference may be determined from the differences of all or particular components of the samples. For example if the local chrominance detail should be determined, the differences of the chrominance components of input sample adjacent to the presently to be processed input sample may be determined. Alternatively, more than one pixel on the same line as the presently to be processed pixel may be used to determine the local detail. The local area may also include pixels of preceding and/or succeeding lines. It has to be noted that the local detail is interpreted to be any local structure. The amount of local detail increases if more detail or structure is present in a predefined area, and/or if more high frequent detail is present in the predefined area.

The color mapper (or color map unit) maps an image signal into a mapped image signal under control of the control signal. The control signal locally changes the intensity and/or the saturation of the image signal as a function of the local detail detected. Consequently, if an artifact is caused which depends on the intensity or the saturation of the present pixel and which is dependent on the local detail at the present pixel, the change of the intensity or the saturation dependent on the local detail decreases the visibility of the artifact.

In an embodiment, the control signal steers the local intensity change of unsaturated colors by the color mapper. If the color mapper maps from a particular color gamut to a larger color gamut, the control signal causes the color mapper to locally decrease an intensity boosting if much local detail is present. With a larger color gamut is meant a color gamut which provides a larger luminance range which usually occurs if more primaries are used. Or said differently, the intensity boosting is decreased as a function of an increase of the local detail. If the mapper maps from a particular color gamut to a smaller color gamut, usually, the control signal causes the color mapper to locally decrease an intensity decrease if much local detail is present. Or said differently, the intensity decrease is decreased as a function of an increase of the local detail. The detail controlled color mapping can also be implemented in systems wherein the input gamut and the output gamut are identical. The image signal received by the color mapper may be the same input image signal as received by the detail detector, but alternatively may be a filtered input image signal. For example, a low-pass filter, which may be adaptive or is an anti-aliasing filter. The filter may be linear or non-linear and is constructed to prevent artifacts occurring is the successive sub-pixel mapping.

Consequently, if much detail is present in the signal to be mapped, the prior art mapping applies the same mapping, for example an intensity boost, as if no detail is present. For particular input image content, such as for example a thin saturated red line in a green background whereby unsaturated red lines are flanking the red line, artifacts occur if the standard high amount of intensity boost is applied. The unsaturated red lines are intensity boosted and thus are brighter in the mapped signal than in the input signal. The saturated red line cannot be boosted and thus keeps its original color and intensity. The effect of the color mapping is that the thin red line becomes much broader. Consequently, the color mapping results in a loss of detail in the displayed image.

The color mapping system in accordance with this embodiment of the present invention detects the high frequent information in the area comprising the thin red line and locally decreases its intensity boost. Thus, the unsaturated red color of the flanking lines changes less towards the color of the saturated red line than in the prior art or even not at all. Consequently, the detail in the input image is preserved in the mapped image. On the other hand, for areas where no detail is present, the prior art intensity boost can be applied without creating artifacts. To conclude: the detail adaptive color mapping in accordance with the present invention has the advantage that the same intensity boosting is obtained as in prior art color mappings in areas with a low amount of detail, while the artifacts in areas with a high amount of detail are decreased.

In an embodiment, the color mapper locally decreases the saturation of saturated colors as a function of the increase of the local detail up to a predefined amount. By lowering the saturation, artifacts caused by a subsequent sub-pixel rendering are decreased. This is illustrated, by way of example, for an RGBW display. The display of a saturated image area on a RGBW display is only possible by driving the RGB sub-pixels. The W sub-pixel cannot be used because the saturated image area would become de-saturated. For example for a fully saturated yellow area, only the R and G sub-pixels are driven to emit light, the B and W sub-pixels do not emit light. For large uniform areas this does not cause any problem. However, for example, a drastic artifact occurs if a thin black line is present in a saturated yellow background. Either, a black pixel of the black line is mapped on an RGB sub-pixel group or on a W sub-pixel. If the pixel falls on a RGB sub-pixel group, the line appears broader because the adjacent W sub-pixel also does not emit light. If the pixel falls on a W sub-pixel, the black pixel gets lost because all the W sub-pixels did already not emit light, while the adjacent RGB sub-pixel group is used to generate the yellow light.

This prior art problem can be alleviated by de-saturating the input signal under control of the detail detected. If no detail is detected, no de-saturation is required and the saturated color of the uniform area is kept saturated. If detail is detected, the saturated color is de-saturated and consequently, the W sub-pixels are able to display information thereby decreasing the artifacts caused by the switched-off W sub-pixels. The thin black line becomes more visible, be it on a less saturated background.

The amount of de-saturation may be dependent on the detail. For example, the amount of de-saturation may increase with increasing detail until a predetermined level of detail. This predetermined level of detail may be the maximum chrominance detail which the display is able to display. If the predetermined level of detail is not the maximum chrominance detail and the detail rises above the predetermined level, the de-saturation decreases with increasing detail.

The de-saturation may be obtained by mixing the luminance intensity of the input RGB pixel with the input sub-pixel intensities R, G, B. The mixing may be a linear addition using weight factors. The weight factors may be controlled by the local detail detected. Alternatively, the average value of the R, G, B sub-pixel intensities is mixed with the individual R, G, B, sub-pixel values. Alternatively, luminance detail (high pass filtered luminance of the input signal) may be added instead of the luminance itself.

Of course, this approach works also for RGBX displays wherein X is an additional primary color, or for any multi-primary display.

In an embodiment the detail detector detects the local detail in the chrominance of the input image signal. For example, the detail in the UV components may be determined. The UV signals may be directly available if the input signal is a YUV signal or may be calculated if the input signal is a RGB signal. This is especially relevant if the artifacts depend on the chrominance of the input image signal samples.

In an embodiment, the detail detector comprises a high pass filter to supply a high-pass filtered image signal which is a high-pass filtered version of the input image signal. A chrominance detail detector receives the high-pass filtered image signal to determine a local difference of chrominance values within an area of the input image signal. The area includes the pixel of the input image signal which has be color mapped. A control signal generator receives the local difference to generate the control signal indicating the local amount of chrominance detail.

In an embodiment, the color mapped image signal has a gamut which is larger (brighter) than a gamut of the first image signal. This is true, for example, for a RGB to RGBW mapping. A color mapping which boost the intensity of unsaturated colors is advantageously implemented in systems wherein the gamut is increased. Such a color mapper is particularly relevant in systems wherein the display gamut is larger than the gamut of the input image signal. For example, usually, the input image signal is defined in the EBU RGB (Red, Green, Blue) gamut while the display pixels comprise, besides the conventional RGB sub-pixels, an additional sub-pixel which for example emits white or yellow light. The addition of the white primary enables to maximally increase the intensity of unsaturated colors.

In an embodiment, the color mapping system comprises a low-pass filter which receives the input image signal and which supplies the low-passed input image signal to the mapper. Such a low-pass filtering is especially advantageous if the display resolution is lower for chrominance than for luminance. This is for example true for configurations with RGBW sub-pixels, such as for example a pentile pixel structure. It has to be noted that the use of a low-pass filter causes smearing of a thin saturated line. In fact, the thin saturated line will be flanked by unsaturated lines. If the prior art color mapping is applied on these smeared lines, as is discussed hereinbefore the detail gets lost. If the color mapping in accordance with the present invention is combined with the low-pass filter, the intensity boosting of the unsaturated lines is decreased decreasing the resolution loss in the color mapped image.

In an embodiment wherein the mapper receives the low-pass filtered input image signal, the low-pass filter is an adaptive low-pass filter which increases its low-pass filtering as a function of an increasing detail. Thus, the same detail detector as used for the mapping can be used to control the adaptive low-pass filtering.

In an embodiment wherein the mapper receives the low-pass filtered input image signal, the adaptive low-pass filter, which low-pass filters the input image to obtain a low-pass filtered input image signal, comprises a low-pass filter and a combiner. The low-pass filter low-pass filters the input image signal to obtain a filtered image signal. The combiner determines the low-pass filtered input image signal as a weighted combination of the input image signal and the filtered image signal. The weighting is controlled in function of the local detail detected. The more weight is allocated to the low-pass filtered signal the more detail is detected.

In an embodiment, the input image signal of the color mapper is identical to the input image signal of the detail detector. The conversion system comprises a low-pass filter which low-pass filters the input image signal to obtain a low-pass filtered image signal. A combiner determines the output image signal as a weighted combination of the low-pass filtered image signal and the mapped image signal. The more weight is allocated to the low-pass filtered signal the more detail is detected. Thus, in local areas with a high amount of detail, the mapped image signal does not or only minimally contribute to the output signal. Consequently, the artifacts caused by the mapper will be minimally added to the output signal.

In an embodiment, the conversion system converts an M-primary image signal into an N-primary image signal, wherein N is greater than M. The conversion system comprises the color mapping system and the multi-primary converter. In the color mapping system both the image signal received by the mapper, and the mapped image signal are M-primary image signals. The multi-primary converter converts the M-primary mapped image signal into the N-primary drive image signal. Such a system has the advantage that the color mapping and the multi-primary conversion are separated and thus can be optimized separately.

In an embodiment, the conversion system converts an M-primary image signal into an N-primary image signal, wherein N is greater than M. The conversion system comprises the color mapping system wherein both the first image signal and the mapped image signal are M-primary image signals, and a multi-primary converter for converting the output image signal which is a combination of the low-pass filtered image signal and the mapped image signal into the N-primary image signal.

These and other aspects of the invention are apparent from and will be elucidated with reference to the embodiments described hereinafter.

### BRIEF DESCRIPTION OF THE DRAWINGS

In the drawings:

FIG. 1 schematically shows a basic block diagram of a conversion system which converts an M-primary image signal into an N-primary image signal,

FIGS. 2A to 2C schematically show drawings illustrating the mapping and the multi-primary conversion,

FIG. 3 schematically shows a block diagram of an embodiment of the color mapping system wherein the adaptive low-pass filter and the adaptive color mapper are arranged in series,

FIG. 4 schematically shows a block diagram of an embodiment of the color mapping system wherein the adaptive low-pass filter and the adaptive color mapper are arranged in parallel,

FIG. 5 schematically shows a block diagram of an embodiment of the color mapping system further performing a detail controlled de-saturation,

FIGS. 6A to 6C schematically show an embodiment of mixing factors in the block diagram of FIG. 5,

FIG. 7 schematically shows a conversion from RGB input samples of the input image into drive values of pentile structured sub-pixels of a display, and

FIG. 8 schematically shows a display device comprising the conversion system.

It should be noted that items which have the same reference numbers in different Figures, have the same structural features and the same functions, or are the same signals. Where the function and/or structure of such an item has been explained, there is no necessity for repeated explanation thereof in the detailed description.

### DETAILED DESCRIPTION

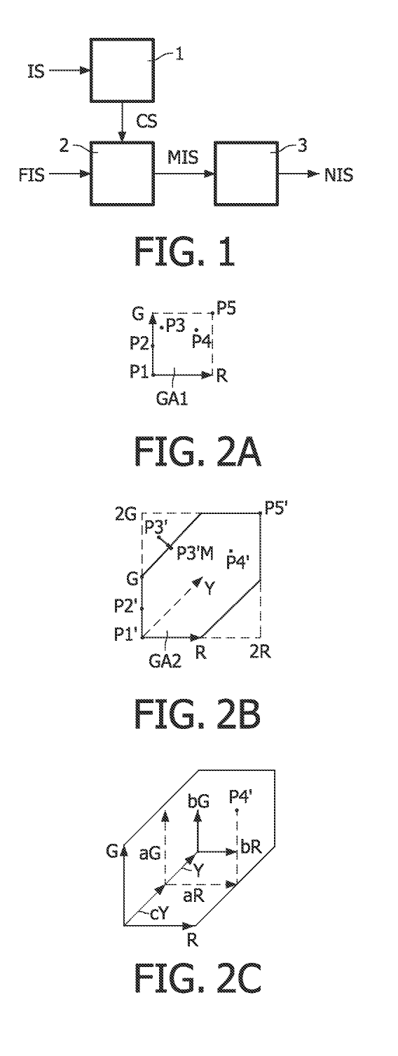

FIG. 1 schematically shows a basic block diagram of a conversion system which converts an M-primary image signal into an N-primary image signal. A color mapper 2 maps its M-primary input image signal FIS into an M-primary mapped image signal MIS. The multi-primary converter 3 converts the M-primary mapped image signal MIS into the N primary image signal NIS. For example, the M-primary input image signal FIS comprises a sequence of input samples which each comprise three components representing three primary colors. The three primary colors usually are red green and blue and are represented by a RGB signal, but may be represented by another signal such as a YUV signal. The input gamut comprises all possible colors (hue, saturation and intensity) which can be represented by the input primary colors. The N primary image signal NIS may be intended for driving N sub-pixels of a pixel of the display on which the image should be displayed. In a RGBW display which has red, green, blue and white sub-pixels, N=4. The output gamut comprises all possible colors which can be represented by the display. In this example wherein a RGB input signal is converted into RGBW display drive signals, the input gamut is smaller than the output gamut. Consequently, the mapper has to perform an intensity boost on unsaturated colors to be able to fill the larger output gamut. The multi-primary converter converts the colors in the mapped image, which are still represented with respect to the input primaries RGB to the drive values RGBW for the display. Such a mapper and multi-primary converter are well known.

In accordance with the present invention, the color mapping system, or the conversion system, which further comprises the detail detector 1 which determines a local detail in the input image signal IS. Thus, in accordance with the present invention, the color mapping system comprises the color mapper 2 and the detail detector 1 but no multi-primary converter 3, while the conversion system further comprises the multi-primary converter 3. The local detail is the detail in a local area of the input image signal IS including the input sample to be converted or to be color mapped. In fact, it is meant that the detail is determined based on input samples which correspond to pixels of the image which occur in the local area. The color mapper 2 is now constructed to perform the intensity boost of the unsaturated colors under control of the local detail detected. The intensity boost is decreased the more detail is detected. Thus, if the difference between closely spaced input samples is large, the intensity boost of the unsaturated colors is small or even zero. Consequently, the original differences are kept as much as possible, thereby preventing a resolution decrease. On the other hand, in areas wherein the differences between closely spaced input samples are small, a large intensity boost can be applied resulting in a brighter image without losing detail.

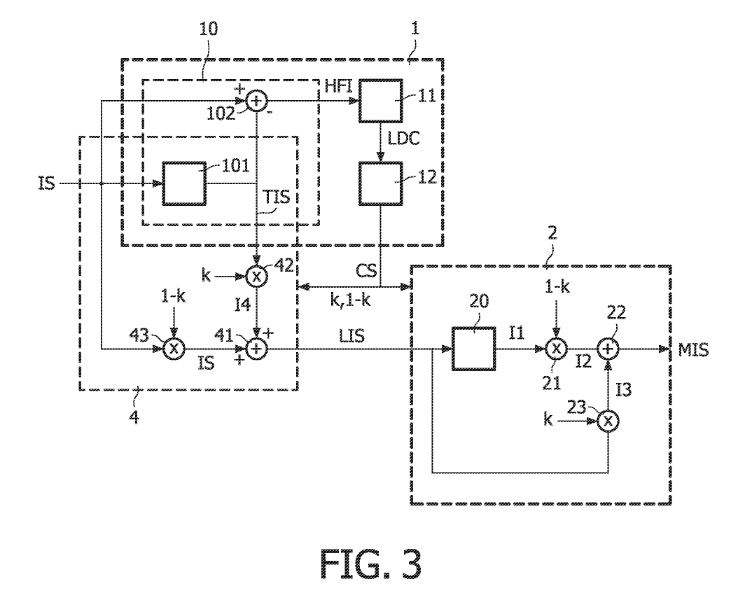

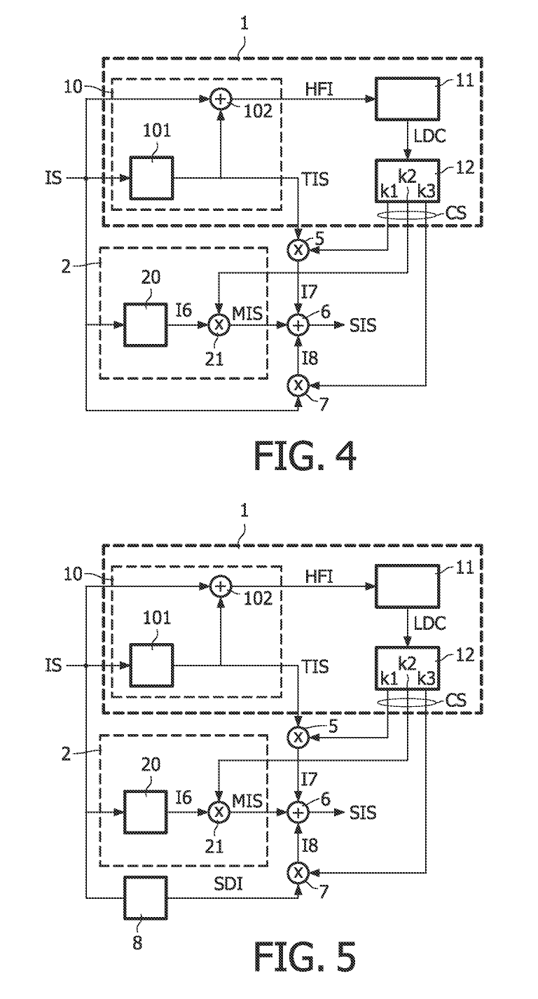

The input image signal IS of the detector 1 and the input image signal FIS of the mapper 2 may be the same image signal, as will be elucidated in more detail with respect to the embodiment of FIG. 4. Alternatively, the input image signal FIS of the mapper 2 may be a low-pass filtered version of the input image signal IS of the detector 1, which will be elucidated in more detail with respect to the embodiment of FIG. 3.

In the above example, wherein the output gamut is larger than the input gamut, a mapper is discussed which maps unsaturated colors on other colors by performing an intensity boost. However, in other systems wherein the input gamut is wider than the output gamut, the mapper may decrease the intensity of unsaturated colors, or may map colors outside the output gamut into the output gamut in any other manner. Even if the input and output gamut are identical, the color mapper may map particular colors to other colors to improve the image in one way or another.

FIGS. 2A to 2C schematically show drawings illustrating the mapping and the multi-primary conversion. In the example shown, for the ease of explanation, the conversion system converts a two primary input signal into a three primary display drive signal. Again, by way of example only, the two primary input signal comprises a red R and a green G primary, and the three primary drive signal comprises a red R, a green G and a yellow Y primary.

FIG. 2A shows the color gamut GA1 comprising all colors of the input samples of the input image signal FIS of the mapper 2. In a practical implementation, the minimum and maximum values of the primary components in the input image signal are limited due to physical constraints. For example, the voltage swing is limited, or the number of bits used to represent the primary components is limited. Therefore, both the primaries R and G have normalized amplitudes in the range from zero to one, including the borders of the range. A few samples P1 to P5 are indicated in FIG. 2A to elucidate how these samples are mapped by the mapper 2, and are converted by the multi-primary converter 3. The sample P1 is black, the sample P2 is saturated green G with half intensity, the sample P3 is near full saturated green G, and the sample P4 is yellow Y with ¾ intensity. The gamut GA1 comprises all the colors which can be reproduced by varying the intensity of the R and G primaries between zero and one.

FIG. 2B shows in the same R and G color space as shown in FIG. 2A a gamut GA2 which can be realized if a yellow primary Y would be added which is the sum of the R and G primaries. The mapper 2 implements an algorithm which maps the input colors in FIG. 2A onto the possible colors within the gamut GA2 of FIG. 2B. A very simple algorithm is to increase for each color in FIG. 2A the values of the primaries R and G with a factor two. Thus, in the example shown, an intensity boost with a factor of two is obtained. Other factors for the intensity boost are possible. The result would be a gamut spanned by primaries 2R and 2G as indicated in FIG. 2B partly with dashed lines. However, as is clear from FIG. 2B, the colors in the left top triangle (spanned by G, 2G, R) and in the right bottom triangle (spanned by R, 2R, G) cannot be reproduced by the sum of the primaries R, G and the primary Y. Therefore, usually, the intensity boosting is not performed on the saturated colors on the G or R axis but only on the unsaturated colors. Further a hard or soft clipping is implemented for colors which occur after the intensity boosting within the above mentioned triangles. For example, in FIG. 2B, the clipping moves a color outside the gamut GA2 into this gamut.

The operation of the mapper 2 is now elucidated by discussing the mapping of the samples P1 to P5 shown in FIG. 2A. The black sample P1 is mapped to black P1′. The saturated green sample P2 is mapped to itself and indicated by P2′. Of the unsaturated sample P4, the R and G values are doubled such that the color P4′ results within the gamut GA2. However, if the R and G values of the unsaturated sample P3 are doubled, the color P3′ results which lies outside the gamut GA2. The color P3′, which cannot be reproduced in a system with the three primaries R, G and Y, is, for example, hard clipped to the color P3′M on the border of the gamut GA2. Thus, the color mapper 2 defines for all the colors of the gamut GA1 how they are converted into colors within the gamut GA2. In fact, the effect of the color mapping discussed is an intensity boosting of non-saturated colors, while saturated colors (R and G) are kept unchanged. It has to be noted that in prior art color mappers, usually a user controllable factor is used instead of a fixed intensity boosting factor of two. This factor may depend on the color of the primaries.

Although in the example shown, the gamuts GA1 and GA2 are different, this is not essential. Alternatively, an image processing may involve a color mapping between two identical gamuts or to a smaller gamut. If the color mapping occurs to a smaller gamut, the intensity boosting may be an intensity decrease. Thus, said more general, the color mapping changes the intensity of unsaturated colors.

Now all colors are within the gamut GA2 which can be represented with the three primaries R, G, Y, the actual multi-primary conversion from the R, G color space to the R, G, Y color space has to be performed such that the three drive signals of the three R, G, Y sub-pixels are obtained. The multi-primary conversion is explained with respect to FIGS. 2B and 2C.

FIG. 2C shows in the R, G, Y color space two examples of many possibilities of how the color P4′ can be obtained by different combinations of values of the three R, G, Y primaries. A first possibility is to sum Y, bR and bG, and a second possibility is to sum cY, aR and aG. Consequently, the task of the multi-primary converter 3 is to select one out of the many possible different combinations. Usually, the multi-primary converter performs this selection process under a constraint, such as for example, to select, if possible, the sum for which the luminance of the Y contribution is equal to the luminance of the combined R and G contribution.

FIG. 3 schematically shows a block diagram of an embodiment of the color mapping system wherein the adaptive low-pass filter and the adaptive color mapper are arranged in series.

The detail detector 1 comprises a high-pass filter 10, a chrominance detail detector 11 and a control signal generator 12. The high-pass filter 10 comprises a low-pass filter 101 and an adder 102. The low-pass filter 101 receives the input image signal IS to supply the low-pass filtered image signal TIS. The adder 102 subtracts the low-pass filtered image signal TIS from the input image signal IS to supply the high-pass filtered image signal HFI. The chrominance detail detector 11 determines the detail in the chrominance of the high-pass filtered image signal HFI. The chrominance signal may be defined by U=R−G, and V=B−G. Now, the chrominance detail detector 11 determines the delta(s) between U values and V values, respectively, for sample values in the local area including the present sample to be processed. The control signal generator 12 receives the delta values, which are also referred to as the local difference LDC, to generate a control signal CS. The control signal CS indicates the local chrominance detail. For example the control signal CS comprises a factor k within the range from zero to one. The factor k increases the more chrominance detail is detected. The low-pass filter may have a one or two-dimensional kernel. The detector 11 may determine instead of the chrominance detail the luminance detail or the total detail in the input image signal IS.

The color mapper 2 in accordance with an embodiment of the present invention comprises a prior art color mapper 20, a multiplier 21, a multiplier 23 and an adder 22. For example, the prior art color mapper 20 performs the mapping as elucidated in FIGS. 2A and 2B. Usually, the color mapper receives a user controllable factor which controls the amount of intensity boost to be applied. In the embodiment shown in FIG. 3, this factor is fixed, for example to its maximum value two. The image signal LIS received by the color mapper 2 is mapped by the prior art color mapper 20 to obtain an image signal I1. The multiplier 21 multiplies the image signal I1 with the factor 1−k to obtain the image signal I2. The multiplier 23 multiplies the image signal LIS, which is the input image signal of the color mapper 20, with the factor k to obtain the image signal I3. The adder 22 sums the image signal I2 and I3 to obtain the mapped image signal MIS.

Thus, if much local detail is detected for the currently processed input sample, the output signal of the color mapper 2 is multiplied by a small value while the image signal LIS is multiplied by a value near to one. Consequently, the mapped image signal MIS is almost identical the input signal LIS of the mapper 2. If no or only a small amount (of high frequent) local detail is detected, the value of the factor k is small (near zero) and the value of the factor 1−k is near one. Consequently, the mapped image signal MIS is almost identical to the prior art mapped image signal I1.

In the embodiment shown in FIG. 3, the color mapper 2 receives an adaptive low-pass filtered input image signal LIS. The adaptive low-pass filter 4 comprises the low-pass filter 101, a multiplier 42, a multiplier 43 and an adder 41. The multiplier 42 multiplies the output image signal TIS of the low-pass filter 101 with the factor k to obtain the image signal I4. The multiplier 43 multiplies the input image signal IS with the factor 1−k to obtain the image signal I5. The adder 41 sums the image signals I4 and I5. Thus, if much local detail is detected, the image signal LIS is equal to the low-pass filtered image signal TIS, and if no local detail is present, the image signal LIS is equal to the input image signal IS. Such an adaptive low-pass filter is especially advantageous if the resolution of the display is higher for luminance than for chrominance, which for example is true for a RGBW sub-pixel. For example, a pentile structure is elucidated with respect to FIG. 5. For this kind of displays, if is known that the luminance resolution of display is sufficient to cater for the luminance resolution of the input signal, the local detail detector 1 determines the local detail in the chrominance only.

It has to be noted that the adaptive low-pass filter 4 as such is known from the non pre-published European patent application 05110562.5 (or PCT application IB2006/054005).

FIG. 4 schematically shows a block diagram of an embodiment of the color mapping system wherein the adaptive low-pass filter and the adaptive color mapper are arranged in parallel. The detail detector 1 shown in FIG. 4 only differs from the detail detector 1 shown in FIG. 3 in that instead of the two factors k and k−1, now, optionally, three factors k1, k2 and k3 are generated which have values dependent on the local detail detected. In FIG. 4, both the detail detector 1 and the color mapper 2 receive the input image signal IS as their input image signal.

The color mapper 2 of this embodiment comprises a prior art color mapper 20 and a multiplier 21. The multiplier 21 multiplies the color mapped image signal I6 from the color mapper 20 with the factor k2 to supply the mapped image signal MIS. Again, this factor k2 should take care that the mapped image signal is suppressed more, i.e. the mapped image signal MIS is closer to the input signal IS, the more local detail is present in the input image signal IS.

The adaptive low-pass filter comprises the low-pass filter 101, the multiplier 5, the optional multiplier 7, and the adder 6. The multiplier 5 multiplies the low-pass filtered image signal TIS with the factor k1 to obtain the image signal I7. The factor k1 should increase with increasing local detail. The multiplier 7 multiplies the input image signal IS with the factor k3 to obtain the image signal I8. The factor k3 should decrease with increasing local detail (and in general holds: k1+k2+k3=1). The adder 6 adds the image signals I7 and I8 and MIS to supply the output image signal SIS. In fact, the adaptive low-pass filter and the controlled color mapper 2 of FIG. 3 are now arranged in parallel thereby minimizing the number of adders and multipliers required.

First, the embodiment without the multiplier 7 is elucidated, the factor k1 may be identical to the factor k in FIG. 3, and the factor k2 may be identical to the factor k−1 in FIG. 3. Thus, if much detail is detected, the output image signal SIS is predominantly determined by the low-pass filtered image signal TIS. If a low amount of detail is present, the output image signal SIS is predominantly determined by the mapped image signal MIS.

In the embodiment with the multiplier 7, it is possible to control the amount of the low-pass filtered input image signal TIS, the mapped input image signal MIS, and the input image signal IS itself as a function of the local detail detected. For example, for a high amount of local chrominance detail the factor k1 is 1 and the factors k2 and k3 are 0 such that the output image signal SIS is the low-pass filtered input signal TIS. The low-pass filtering 101 may only be applied on the chrominance components of the input signal IS. For a low amount of local chrominance detail the factors k1 and k3 may be 0 and the factor k2 is 1. The factor k3 may be non-zero for in-between amounts of chrominance detail. Alternatively, independent or dependent on the amount of local detail, the factor k3 may be controlled such that it also contributes to the output image signal SIS. This has the advantage that a low-pass filtered signal is obtained if much chrominance detail is present and the original (unfiltered) signal is obtained if a low amount of chrominance detail is present. Thus, now a selection is possible wherein not only the low-pass filtered input signal TIS and the mapped input image signal MIS, but also the input image signal IS itself can contribute to the output signal.

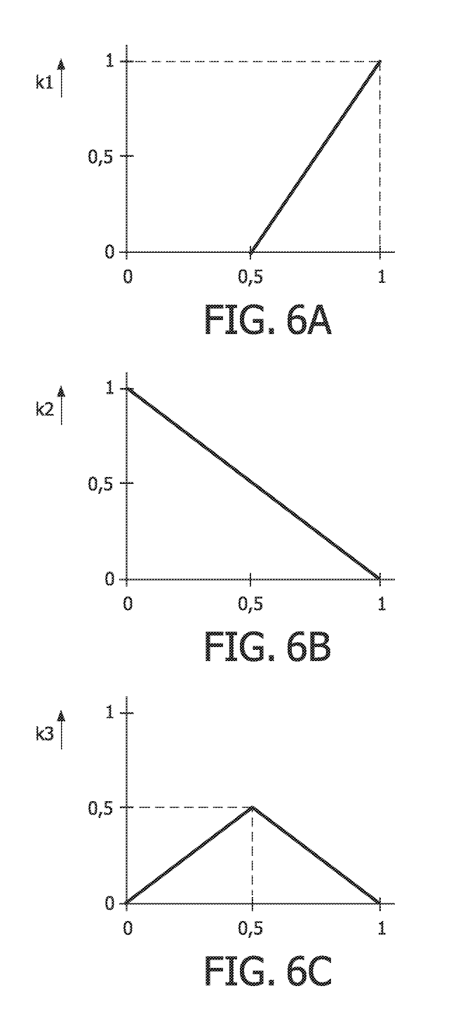

FIG. 5 schematically shows a block diagram of an embodiment of the color mapping system further performing a detail controlled de-saturation. This block diagram is largely identical to that of FIG. 4. The only difference is that the de-saturation block 8 has been added to the branch which provides the input signal IS to the multiplier 7. Thus, instead of adding a fraction of the input signal IS, now a fraction of the de-saturated input signal SDI is contributing to the output signal SIS. The fraction and thus the amount of local de-saturation is determined by the local detail dependent factor k3. The de-saturation may be obtained by mixing the luminance intensity of the combined input R, G, B pixels of the input signal IS with the individual input sub-pixel intensities R, G, B. The mixing may be a linear addition using weight factors. The weight factors may be constant or may be controlled by the local detail detected. Alternatively, the average value of the R, G, B sub-pixel intensities is mixed with the individual R, G, B, sub-pixel values. Alternatively, luminance detail (high pass filtered luminance of the input signal) may be added instead of the luminance itself. The operation of the system depicted in the block diagram of FIG. 5 is further elucidated with respect to FIG. 6.

FIGS. 6A to 6C schematically show an embodiment of mixing factors in the block diagram of FIG. 5. FIGS. 6A, 6B and 6C show the factors k1, k2 and k3, respectively, as function of the local detail detected. The local detail is depicted along the horizontal axis and is normalized in the range zero (no detail) to one (maximum detail which can be displayed). Or said differently, a low value of the local detail indicates a low content of high frequencies (or local structure), a high value of the local detail indicates a high content of high frequencies (or local structure).

The factor k2 controls the contribution of the mapped input image signal MIS to the output image signal SIS. This factor k2 is one for areas with low detail and gradually decreases to zero for areas with maximum detail. Consequently, the amount of color or gamut mapping decreases with increasing local detail thereby decreasing artifacts caused by the color or gamut mapping in areas with high local detail.

The factor k1 controls the contribution of the low-pass filtered input signal TIS to the output image signal SIS. If the local detail is low, the mapper 20 can be fully active without causing artifacts. Consequently, the factor k1 can be zero for low local detail. If a lot of local detail is present, the mapper output signal is suppressed and more low-pass filtered signal TIS is added to the output signal SIS because the low-passed signal has a sufficiently low resolution to be displayed without artifacts. Thus, the factor k1 starts increasing from its zero value at a particular local detail (in the example shown at 0.5) to its maximum value one at maximum local detail. In an embodiment, the local detail is local chrominance detail.

The factor k3 controls the contribution of the saturation decreased image signal SDI. The factor k3 is zero for low local detail: if no local detail is present in the input image signal IS, the saturation need not be decreased. If the local detail increases, the factor k3 increases too to add more of the saturation decreased image signal SDI to the output image signal SIS to minimize the artifacts caused by local detail in saturated backgrounds. At a predetermined value of the local detail, the contribution of the saturation decreased image signal SDI to the output signal is decreased with increasing local detail because the chrominance resolution of the display is too low to display this information and it is better to use the low-pass filtered image signal TIS. It has to be noted that optionally, as discussed hereinbefore, also a weighted (the factor k4) contribution of the input image signal IS can be implemented.

The amount of de-saturation may be dependent on the detail. For example, the amount of de-saturation may increase with increasing detail until a predetermined level of detail. This predetermined detail may be the maximum chrominance detail which the display is able to display. If the detail rises above the predetermined level, the de-saturation may decrease with increasing detail to prevent artifacts in highly detailed areas.

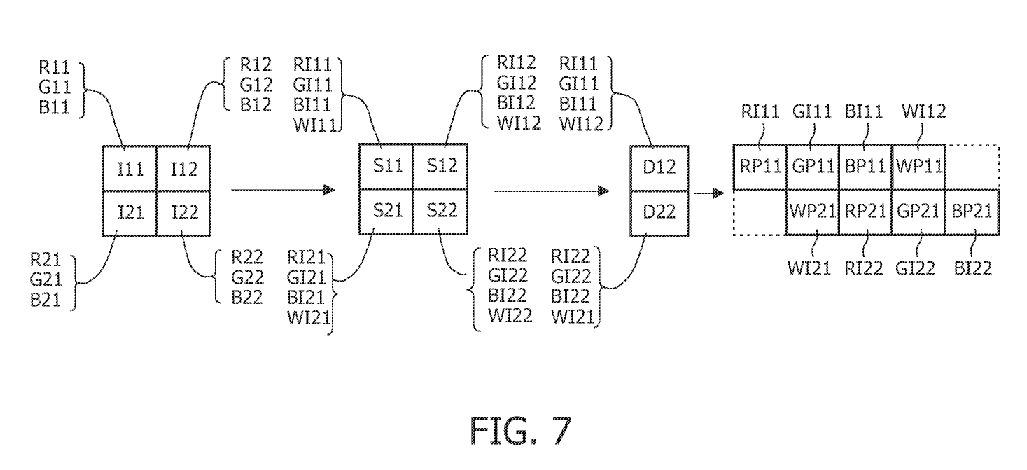

FIG. 7 schematically shows a conversion from RGB input samples of the input image into drive values of sub-pixels of a RGBW display. FIG. 7 explains the conversion, by way of example only, for a particular configuration of sub-pixels.

Because the resolution of mobile displays keeps increasing, the pixel pitch and thus the size of the sub-pixels of the pixel decreases. However, the electronics in each sub-pixel, such as wiring and thin film transistor do not scale with the size of the pixels, the aperture of the sub-pixels decreases even faster than their size. Consequently, the luminance and thus the power consumption of the backlight must increase to obtain the same brightness of the image displayed. In conventional red, green, blue displays (further also referred to as RGB displays), each sub-pixel comprises a red, green and blue sub-pixel. If a backlight unit generates white light, for each of the sub-pixel a color filter is required which maximally is able to transmit only one third of the impinging white light. The addition of a white sub-pixel to the red, green and blue sub-pixels may improve the brightness because no color filter is required for the white (W) sub-pixel and thus the white light of the backlight unit is substantially completely transmitted. Of course, with an extra white pixel, only the luminance of unsaturated colors can be boosted.

The display pixels have RGBW sub-pixels arranged in a particular configuration. In the configuration shown in FIG. 7, two input pixels are displayed on one display pixel: one of the two input pixels is displayed on the RGB sub-pixels of the display pixel, and the other one of the two input pixels is displayed on the W sub-pixel. Appropriate sub-pixel rendering is used in order to provide the same perceived resolution as conventional RGB striped technology wherein the sub-pixels with the same color are arranged in columns, and one input pixel is displayed by one display pixel. This configuration uses only two third of the sub-pixel columns to obtain, on average, two sub-pixels per pixel and thus provides a larger pixel aperture than the conventional RGB striped technology. Note that the present invention has benefits on any RGBW subpixel configuration, or even on other (RGBX or more general) multi-primary configurations.

A conversion system which converts the standard RGB image signal into drive signals for the RGBW sub-pixels comprises a gamut mapping 2 and a multi-primary conversion 3. The gamut mapping 2 maps the input RGB gamut GA1 onto the different gamut GA2 which can be represented with the RGBW sub-pixels. Roughly speaking this mapping boosts the intensity of unsaturated colors. If the boosted unsaturated color occurs outside the RGBW gamut GA2, it is clipped to the border (hard clipping) or even inside (soft clipping) the RGBW gamut GA2. Saturated colors are not intensity boosted. The multi-primary conversion 3 converts the mapped RGB values into RGBW drive values suitable for driving the RGBW sub-pixels. The multi-primary conversion is succeeded by sub-pixel sampling which halves the number of sub-pixels being driven by the same input pixel. The sub-pixel sampling method discards the driving value for white (mapping the RGBW pixel on a RGB sub-pixel triplet), or discards the driving value for red, green, blue (mapping the RGBW pixel on a white sub-pixel). This does not affect the luminance resolution, because both the RGB triplet and the white sub-pixel are used as luminance pixels, but lowers the chrominance resolution.

FIG. 7 shows an example of this conversion for a block of four adjacent RGB input pixels I11, I12, I21, I22 of the input image. Each RGB input pixel Iij comprises three values Rij, Gij, Bij. The conversion first performs the mapping 2 and the multi-primary conversion 3 to obtain the corresponding four RGBW values S11, S12, S21, S22 in the RGBW gamut GA2. Each one of the four RGBW values Sij comprise four values RIij, GIij, BIij, and WIij. The set of four RGBW values S11, S12, S21, S22 are sub-sampled into two RGBW drive signals D12, D22 which each comprise 4 sub-pixel drive values for corresponding sub-pixels RP11, GP11, BP11, WP11 of a first pixel, and WP21, RP21, GP21, BP21 of a second pixel, respectively, of the pentile configured display. The sub-sampling selects the RGB values RI11, GI11, BI11 of the values S11 and the W value W12 of the values S12 for the first pixel which comprises the sub-pixels RP11, GP11, BP11, WP11. The sub-sampling selects the RGB values R122, G122, B122 of the values S22 and the W value W21 of the values S21 for the first pixel which comprises the sub-pixels WP21, RP21, GP21, BP21.

The chrominance resolution of such a display is half its luminance resolution. Both the RGB triplet of sub-pixels and the W sub-pixel contribute to the luminance, but only the RGB sub-pixels can display color information. If small text or thin lines (for example one pixel wide) with saturated colors are present in the input image, detail may get lost. Or said differently, information in the input image with a chrominance resolution which is as high as the highest luminance resolution which can be displayed on the RGBW sub-pixel configuration cannot be displayed on the RGBW display without artifacts because its resolution is too high. These artifacts can be minimized by low-pass filtering the chrominance components (U and V of a YUV signal) of the input image. Alternatively, the adaptive low-pass filter may be used which increase the contribution of the low-pass filtered input image signal if more chrominance detail is detected. This reduces the chrominance resolution of input images without deteriorating the luminance resolution. As disclosed in the non-pre-published European patent application 05110562.5 this low-pass filtering may be controlled dependent on the local detail in an area comprising the input pixel which is being processed. However, still artifacts may occur for the special input signals referred to earlier. In the embodiment discussed with respect to FIG. 7, these artifacts are decreased by also controlling the mapping dependent on the local detail.

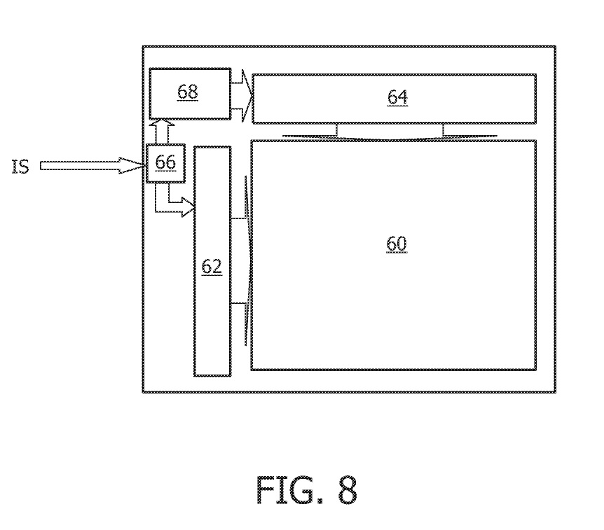

FIG. 8 schematically shows a display device comprising the conversion system. The display device comprises an array 60 of display pixels which are driven by a select driver 62 and a data driver 64. The select driver 62 may select the pixels line by line to enable the data driver 64 to provide the data line-wise to the selected line of pixels. The RGB input image samples IS which determine the color and intensity of the input pixels are supplied to a display controller 66. The unit 68 comprises the color mapping unit (the color mapping system in the claims) which comprises the detail detector 1 and the color mapper 2. Alternatively, the unit 68 comprises the conversion system which comprises the color mapping system, the detail detector 1 and the multi-primary conversion 3. Both the color mapping system and the conversion system may additionally comprise the local detail controlled chrominance low-pass filter. The unit 68 may comprise a microprocessor for implementing the signal processing functions.

Although in this embodiment, the sub-pixel sampling problem is described for RGBW displays, it also may exist for other displays, especially if the resolution of the display is not identical for luminance and chrominance components. Some examples are RGBx displays wherein the additional sub-pixel x can have any color, for example yellow or cyan. The same issue may arise in conventional RGB displays in which sub-sampling is applied, or in displays wherein a low-pass filtering on part of the input components of the input pixels is applied.

Although in this embodiment a particular configuration of the sub-pixels is shown, the present invention may be relevant to other implementations in which another configuration of sub-pixels is used.

It should be noted that the above-mentioned embodiments illustrate rather than limit the invention, and that those skilled in the art will be able to design many alternative embodiments without departing from the scope of the appended claims.

The present invention may be advantageously implemented in, for example, LCD's (Liquid Crystal Displays), PDP's (plasma display panels), DMD (micro mirror device), VCSELs displays (vertical-cavity surface-emitting lasers), LED or OLED (organic light emitting diode display).

The invention can be applied to image signals independent on how the pixel intensity and color are defined. The color data may be converted into the desired format, for example the RGB format, to be processed in accordance with the present invention.

Although the present invention has a wider field of application, the invention is of particular benefit for displays with lower chrominance resolution than luminance resolution. This is, for example, true for RGBW displays, and in particular for displays in which the display is driven with a sub-sampled set of sub-pixel values. Of course, this approach can also advantageously used for RGBX displays wherein X is an additional primary color.

Local image structure may typically be any spatial relationship between pixels of related color values, e.g. there may be a texture present such as e.g. dark grains of a certain size on a lighter local background. This can be characterized by a measure, e.g. a texture measure, or some value output from a recognizer (e.g. a class number of local shape, from a pattern matcher, or a learning system analyzing the local spatio-color pixel distributions, statistically, semantically, etc.), etc. This is then converted to a control signal, which may e.g. be one of a number of values (e.g. high=complex texture; low=simpler texture), or a continuous curve, or even multidimensional signal (of course, or a continuous curve, or even multidimensional signal (of course there may be an additional or comprised mapping so that the final contrast signal is of the correct magnitude to do the color transformation, so that e.g. for an average viewer the output picture is more pleasing).

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A color mapping system comprising:
a detector (1) arranged to analyze a local image structure in an image (IS) and to output a image structure measure usable for generating a control signal (CS) indicating a type of local image structure in the image (IS),
a color mapper (2) for mapping a first image signal (FIS) into a mapped image signal (MIS) by means of a color transformation under control of the control signal (CS), such as for locally changing an intensity and/or a saturation of the first image signal (FIS) as a function of the local image structure.

2. A color mapping system as in claim 1 comprising:
a detail detector (1) for generating a control signal (CS) indicating local detail in an input image, the input image being defined by an input image signal (IS),
a color mapper (2) for mapping a first image signal (FIS) into a mapped image signal (MIS) by means of a color transformation under control of the control signal (CS), such as for locally changing an intensity and/or a saturation of the first image signal (FIS) as a function of the local detail, wherein the first image signal (FIS) is the input image signal (IS) or a filtered input image signal (LIS).

3. A color mapping system as claimed in claim 1, wherein the color mapper (2) is constructed for generating an intensity change of unsaturated colors.

4. A color mapping system as claimed in claim 3, wherein the color mapper (2) is constructed for generating the intensity change of the unsaturated colors to locally decrease the intensity as a function of the increase of the local detail, or to locally increase the intensity as a function of the increase of the local detail.

5. A color mapping system as claimed in claim 2, wherein the color mapper (2) is constructed for locally decreasing a saturation of saturated colors as a function of the increase of the local detail.

6. A color mapping system as claimed in claim 2, wherein the detail detector (1) is constructed for generating the control signal (CS) indicating the local detail of a chrominance component of the input image signal (IS).

7. A color mapping system as claimed in claim 6, wherein the detail detector (1) comprises:
a high pass filter (10) for supplying a high-pass filtered image signal (HFI) being a high-pass filtered input image signal (IS),
a chrominance detail detector (11) for receiving the high-pass filtered image signal (HFI) to determine a local difference (LDC) of chrominance values within an area of the input image signal (IS), the area including a presently to be color mapped pixel of the input image signal (IS), and
a control signal generator (12) for receiving the local difference (LDC) to generate the control signal (CS) indicating the local amount of chrominance detail.
FIGS. 1, 3 and 4

8. A color mapping system as claimed in claim 1, wherein the color mapped image signal (MIS) has a second gamut (GA2) being larger than a first gamut (GA1) of the first image signal (FIS).

9. A color mapping system as claimed in claim 8, wherein the first gamut (GA1) is defined by three primaries (R, G, B) and the second gamut (GA2) is defined by the three primaries (R, G, B) and a white primary (W).

10. A color mapping system as claimed in claim 2, wherein the color mapping system comprises a low-pass filter (4) for receiving the input image signal (IS) to supply the first image signal (FIS) being low-passed filtered.

11. A color mapping system as claimed in claim 10, wherein the low-pass filter (4) is an adaptive low-pass filter (4) being coupled to the detail detector (1) for increasing its amount of low-pass filtering as a function of an increasing detail.

12. A color mapping system as claimed in claim 11, wherein the adaptive low-pass filter (4) comprises:
a low-pass filter (101) for receiving the input image signal (IS) to supply a third image signal (TIS), and
a combiner (41) for supplying the low-pass filtered input image signal (LIS) being a weighted combination of the input image signal (IS) and the third image signal (TIS).

13. A color mapping system as claimed in claim 1, wherein the first image signal (FIS) is the input image signal (IS), and wherein the conversion system further comprises:
a low-pass filter (101) for receiving the input image signal (IS) to supply a third image signal (TIS),
a combiner (6) for supplying an output image signal (SIS) being a weighted combination of the third image signal (IS) and the mapped image signal (MIS).

14. A conversion system for converting an M-primary image signal (R, G, B) into an N-primary image signal (R, G, B, W) wherein N is greater than M, the conversion system comprises:
the color mapping system as claimed in claim 6 wherein both the first image signal (FIS) and the mapped image signal (MIS) are M-primary image signals, and
a multi-primary converter (3) for converting the mapped image signal (MIS) into the N-primary image signal (NIS).

15. A conversion system for converting an M-primary image signal (R, G, B) into an N-primary image signal (R, G, B, W) wherein N is greater than M, the conversion system comprises:
the color mapping system as claimed in claim 11 wherein both the first image signal (FIS) and the mapped image signal (MIS) are M-primary image signals, and
a multi-primary converter (3) for converting the output image signal (SIS) into the N-primary image signal (NIS).

16. A display apparatus comprising:
the color mapping system as claimed in claim 1,
a display having pixels comprising sub-pixels, and
a display driver for receiving the mapped image signal (MIS) to generate drive signals for the sub-pixels.

17. A color mapping method comprising:
generating a control signal (CS) indicating local image structure in an input image signal (IS), and
color mapping (2) a first image signal (FIS) into a mapped image signal (MIS) under control of the control signal (CS) for locally changing an intensity and/or a saturation of the first image signal (FIS) as a function of the local image structure.

18. A computer program product comprising computer code for performing the steps of:
generating a control signal (CS) indicating a local image structure in an input image signal (IS),
color mapping (2) a first image signal (FIS) into a mapped image signal (MIS) under control of the control signal (CS) for locally changing an intensity and/or saturation of the first image signal (FIS) as a function of the local image structure.
